(19) United States
(12) Patent Application Publication
(10) Pub. No.: US 2011/0283348 A1
(43) Pub. Date: Nov. 17, 2011

(54) SYSTEM AND METHOD FOR DETERMINING FIREWALL EQUIVALENCE, UNION, INTERSECTION AND DIFFERENCE

(75) Inventors: Yibei Ling, Belle Mead, NJ (US); Aditya Naidu, Edison, NJ (US); Rajesh Talpade, Madison, NJ (US)

(73) Assignee: TELCORDIA TECHNOLOGIES, INC., Piscataway, NJ (US)

(21) Appl. No.: 12/779,069

(22) Filed: May 13, 2010

(51) Int. Cl. G06F 21/00

(52) U.S. Cl. 726/11

(57) ABSTRACT

Aspects of the invention pertain to integrated compliance analysis of multiple firewalls and access control lists for network segregation and partitioning. Access control lists may have many individual rules that indicate whether information can be passed between certain devices in a computer network. The access control lists in different firewalls in different network segments within a given network may overlap or have inconsistent rules. Aspects of the invention generate differences between firewalls, analyze equivalency of firewalls, generate the intersection (if any) between a pair of firewalls, and generate the union (if any) between firewalls. Such information provides an integrated analysis of multiple interrelated firewalls, including inbound and outbound access control lists for such firewalls, and may be used to manage firewall operation within the network to ensure consistent operation and maintain network security. It also addresses a wide range of security questions that arise when dealing with multiple firewalls.

### BACKGROUND OF THE INVENTION

1. Field of the Invention

The invention generally relates to network security and network management of multiple network security segments. More particularly, aspects of the invention are directed to integrated compliance analysis of multiple firewalls in the context of network segregation and partitioning.

2. Description of Related Art

A computer network permits rapid exchange of information among various points or nodes in the network. User devices such as laptop computers, mobile phones and PDAs allow users to access content such as e-mail, videos, web pages, etc. User devices connect to other devices such as servers that provide the content.

Access may be limited to certain devices or a collection of nodes (e.g., specific IP addresses or ports or subnets) within the enterprise network or home. Information regarding permission or denial of access is maintained by a firewall and used to block or permit traffic flow accordingly. Depending on the size or complexity of the network and its security policies, there may be multiple firewalls handling traffic at different points or partitions in the network.

An Access Control. List (“ACL”) is a rule-based packet classifier. It plays an essential role in enterprise networks controlling traffic flow and for managing the network from intrusion and ensuring network security. ACLs are one of the most important security features in managing access control and network security policies in large scale enterprise networks. An ACL contains a list of rules that define matching criteria inside packet header.

Each firewall may have its own ACL. When there are multiple firewalls at different points or partitions in the network, a potential conflict among the ACLs is possible. For instance, traffic may pass through a primary level firewall due to its ACL permissions, but be blocked by a secondary level firewall due to a different set of ACL permissions. Or, conversely, the secondary level firewall may be configured to accept packets from a given source, but will never receive them due to the ACL configuration of the primary level firewall.

Due to system complexity, it may be very difficult to identify unintended conflicts or gaps in the ACLs of a system's firewalls. This can degrade system operation or prevent important information from reaching its intended destination. Therefore, the ability of integrated compliance analysis of multiple firewalls is essential in the context of network segregation and partitioning.

### SUMMARY OF THE INVENTION

Systems and methods are provided which can identify ACL conflicts and gaps. Once identified, the ACLs may be reconfigured to resolve such issues. In accordance with aspects of the invention, multiple firewalls are analyzed to determine or otherwise generate the difference, union, intersection and equivalence among them. The analysis is desirably performed on both inbound and outbound ACLs. Integrated analysis of multiple firewall combinations leads to a comprehensive understanding of system operation, and helps to address security issues that may arise when dealing with multiple firewalls.

In accordance with one embodiment of the invention, a method of processing access control lists in a computer network. The method comprises obtaining a plurality of access control lists and storing the plurality of access control lists in memory, the access control lists each comprising a plurality of rules for permitting or denying access to resources in the computer network; generating an order-free equivalent for each of the plurality of access control list; storing the order-free equivalents for the plurality of access control lists; determining a set of permit entries from each order-free equivalent to identify which of the plurality of rules permit the access to the resources in the computer network; and using the order-free equivalents for each of the plurality of access control lists and the set of permit entries from each order-free equivalent to manage firewall operations in the computer network.

In one alternative, the method further comprises generating any differences between first and second ones of the access control lists upon determining the set of permit entries associated with the first and second access control lists. In an example, the method desirably includes analyzing whether the first and second access control lists are equivalent upon generating any differences between the first and second access control lists. In another example, the method may further include analyzing whether an intersection exists between the first and second access control lists upon generating any differences between the first and second access control lists. In another alternative, the method further comprises analyzing whether a union exists between the first and second access control lists upon determining the set of permit entries from each order-free equivalent.

In another embodiment, an apparatus for processing access control lists in a computer network is provided. The apparatus comprises memory for storing information associated with a plurality of access control lists and a processor means. The processor means is used for obtaining a plurality of access control lists and storing the plurality of access control lists in memory. The access control lists each comprise a plurality of rules for permitting or denying access to resources in the computer network. The processor means is further configured for generating an order-free equivalent for each of the plurality of access control list; storing the order-free equivalents for the plurality of access control lists; determining a set of permit entries from each order-free equivalent to identify which of the plurality of rules permit the access to the resources in the computer network; and using the order-free equivalents for each of the plurality of access control lists and the set of permit entries from each order-free equivalent to manage firewall operations in the computer network.

In one alternative, the processor means is further configured for generating any differences between first and second ones of the access control lists upon determining the set of permit entries associated with the first and second access control lists. In another alternative, the processor means is further configured for analyzing whether the first and second access control lists are equivalent upon determining any differences between the first and second access control lists.

In a further alternative, the processor means is also configured for analyzing whether an intersection exists or for generating an intersection between the first and second access control lists upon determining any differences between the first and second access control lists. In yet another alternative, the processor means is further configured for analyzing whether a union exists between the first and second access control lists upon determining the set of permit entries from each order-free equivalent.

In accordance with another embodiment, a computer-readable recording medium is provided which has instructions stored thereon, the instructions, when executed by a processor, cause the processor to perform a method of processing access control lists in a computer network, the method comprising obtaining a plurality of access control lists and storing the plurality of access control lists in memory, the access control lists each comprising a plurality of rules for permitting or denying access to resources in the computer network; generating an order-free equivalent for each of the plurality of access control list; storing the order-free equivalents for the plurality of access control lists; determining a set of permit entries from each order-free equivalent to identify which of the plurality of rules permit the access to the resources in the computer network; and using the order-free equivalents for each of the plurality of access control lists and the set of permit entries from each order-free equivalent to manage firewall operations in the computer network.

### BRIEF DESCRIPTION OF THE DRAWINGS

FIG. 1 illustrates an exemplary computer network employing a firewall.

FIG. 2 illustrates an exemplary multilayered firewall configuration.

FIG. 3 illustrates a flow diagram showing a process for managing multiple firewalls in accordance with aspects of the invention.

FIGS. 4(a)-(f) illustrate order dependency on individual ACL entries in accordance with aspects of the invention.

FIG. 5 illustrates a flow diagram showing a process for constructing order-free equivalent ACLs in accordance with aspects of the invention.

FIG. 6 is a pseudocode representation of the order-free equivalent process of FIG. 5.

FIG. 7 is a pseudocode representation for obtaining permit entries in accordance with, aspects of the invention.

FIG. 8 is a pseudocode representation for determining the difference between firewalls in accordance with aspects of the invention.

FIG. 8A illustrates examples of asymmetrical different determinations.

FIG. 9 is a pseudocode representation for determining equivalence between firewalls in accordance with aspects of the invention.

FIG. 10 is a pseudocode representation for determining the intersection between firewalls in accordance with aspects of the invention.

FIG. 11 is a pseudocode representation for determining the union between firewalls in accordance with aspects of the invention.

FIG. 12 illustrates a computer network for use with aspects of the invention.

### DETAILED DESCRIPTION

Aspects, features and advantages of the invention will be appreciated when considered with reference to the following description of preferred embodiments and accompanying figures. The same reference numbers in different drawings may identify the same or similar elements. Furthermore, the following description is not limiting; the scope of the invention is defined by the appended claims and equivalents.

For detailed discussions regarding aspects of access control lists, see co-pending U.S. patent application Ser. No. 12/634,975, filed Dec. 10, 2009, attorney docket number APP 1879, and co-pending U.S. patent application Ser. No. 12/634,984, filed Dec. 10, 2009, attorney docket number APP 1903, the entire disclosures of which are incorporated by reference herein.

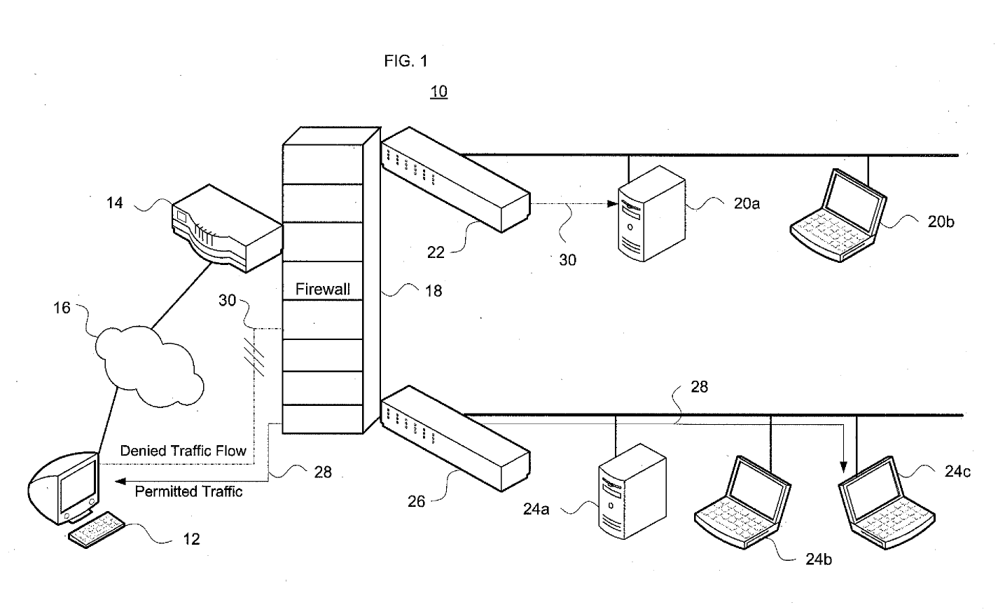

FIG. 1 illustrates an exemplary computer network 10 including a user computer 12 connected to a network router via the Internet 16. Firewall 18 filters inbound and outbound data packets. The terms firewall and ACL are used interchangeably herein. An outbound ACL (18) filters data packets from the router 14, and an inbound ACL (18) filters data packets send to the router 14. While only a single element 18 is shown, a network interface may have both inbound and outbound ACLs. In this case, the inbound and outbound ACLs could be independent of each other. Inbound ACL controls incoming data packet entering the network interface, while outbound ACL controls outgoing data packets from the network interface. From the perspective of device 12, a first set of computers 20a and 20b behind the firewall 18 may be accessed via interfaces 14 and 22. And a second set of computers 24a, 24b and 24c may be accessed via interfaces 14 and 26.

Depending on maintained ACL information, traffic flow may be permitted or denied. As shown, traffic may be permitted between the user computer 12 and the computer 24c coupled to second interface 26 as shown by arrow 28. In contrast, traffic from the user computer 12 to the computer 20a may be blocked by the firewall 18, as shown by the dashed arrow 30

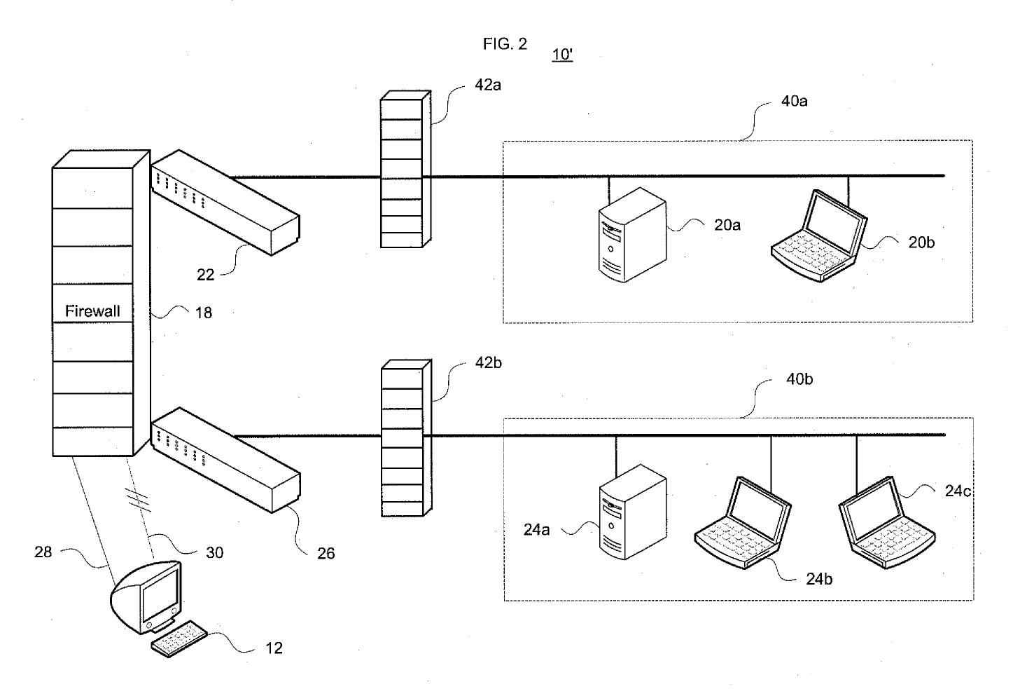

FIG. 2 illustrates an alternative network configuration 10′, which includes multiple firewalls. As with the network 10 of FIG. 1, the firewall 18 filters data packets send to or from devices, such as use computer 12, within the network configuration 10′. ACL 42a attaches to network interface 22 and ACL 42b attaches to network interface 26. An ACL (inbound or outbound) is always associated with a network interface). By way of example only, these entities may represent different logical entities such as virtual private networks, different organizations within a company or government entity, different departments within a college or university, etc. Each entity 40a and 40b may have its own respective firewall 42a or 42b, or multiple firewalls (not shown). While only a pair of entities 40a-b and firewalls 42a-b are shown, additional entities and firewalls may be part of the network configuration 10′. The firewalls may operate in parallel or in layers depending upon the network configuration and security requirements. For example, traffic between 12 and 24a should be permitted by both ACLs on network interface 14 (FIG. 1) and on network interface 42b (FIG. 2). This poses a firewall intersection problem.

Each network interface is desirably configured with its own ACLs (inbound or outbound ACLs). Resembling an if-then statement in the C programming language, the generic syntax of an ACL rule is typically expressed in the form of the if condition then action. The condition may specify source, destination IP address, protocol and port ranges. The action is binary, either permit or deny. While seemingly straightforward, in practice ACLs may be long, complex and error-prone. Furthermore, there may be hundreds or thousands of ACL rules implemented by each firewall in the network.

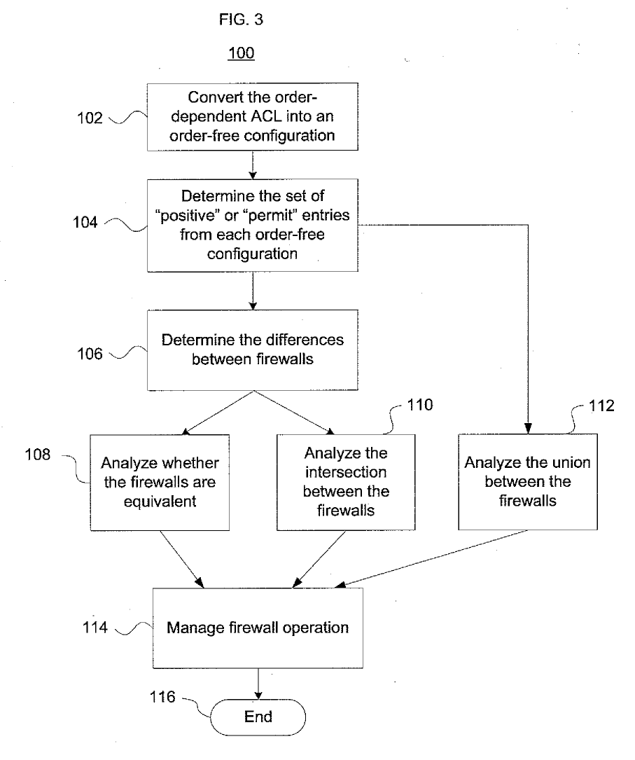

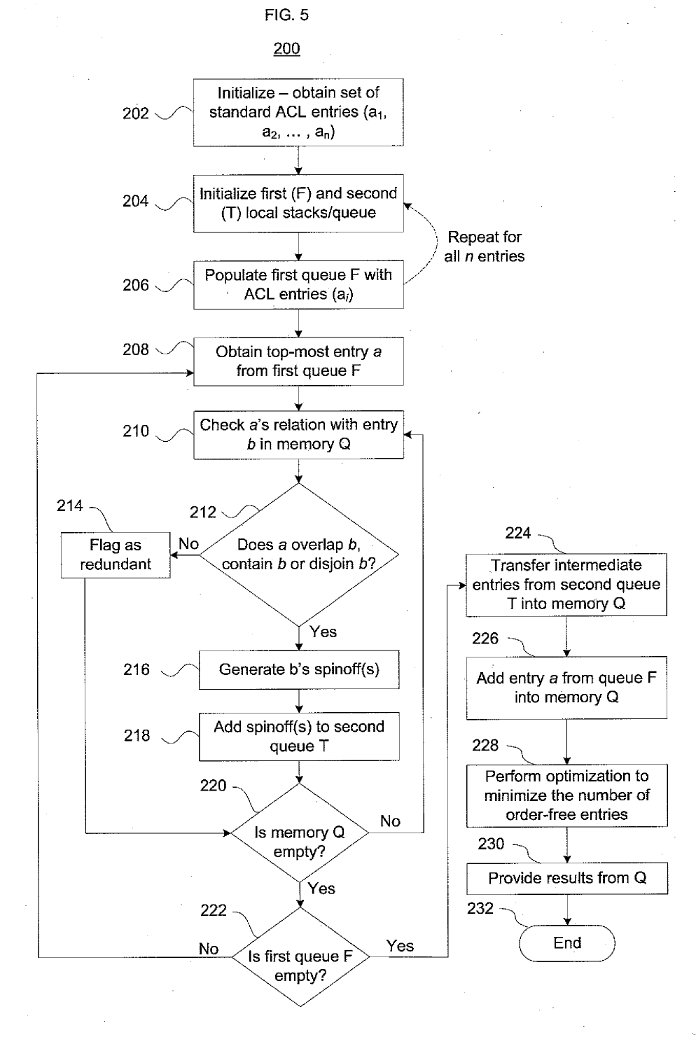

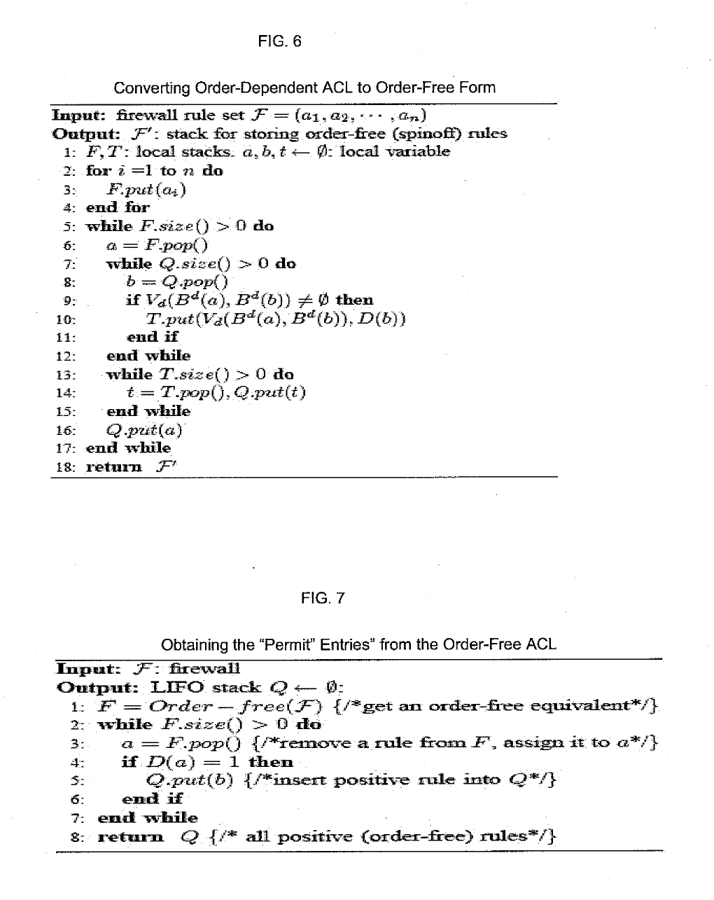

FIG. 3 illustrates a process 100 for managing firewalls in accordance with aspects of the invention. As shown in block 102, the system first determines an order-free equivalent for order-dependent ACLs of each firewall under consideration. As used herein, the term “ordering” is generic, and is applicable to both the first-matching rule in commonly-used ACLs as well as priority-based ACLs. In one aspect, a framework allows construction of an order-free equivalent by recursively gluing together projected results on each involved dimension. The terms “order-independent” and “order-free” are used interchangeably herein. The terms “entry” and “rule” are also used interchangeably herein. A process for converting order-dependent ACLs into order-free equivalents will be discussed in detail below with regard to FIGS. 5-6.

Turning to block 104, once the order-free configuration for a given ACL has been obtained, a set of “positive” or “permit” entries from that order-free configuration is determined. Such entries are those which permit data packets to be sent through the firewall. As shown in block 106, once the permit entries for the order-free ACL configurations have been determined, differences between a given pair of firewalls are obtained. The difference may be asymmetric. In other words, A−B≠B−A. Using the above, additional details regarding the ACLs may be obtained. For instance, as shown in block 108, the system may determine whether the firewalls under consideration are equivalent. The system may also analyze the intersection between the firewalls, as shown in block 110. In a further example shown in block 112, the system may use the results from block 104, namely the sets of permit entries from each order-free ACL configuration, and analyze the union between firewalls. Such system operations will be described below in relation to FIGS. 7-11.

Once the processing from some or all of blocks 102-112 has been performed, the system may use the results to manage firewall operation as shown in block 114. Thus, information regarding whether firewalls are equivalent, intersect, have a union and/or have specific differences may be employed to reconfigure or reorganize firewall arrangements. By way of example only, the ACLs for such firewalls may be revised to ensure compliance with security or access policies, or streamlined to reduce redundancies. The process of FIG. 3 ends at block 116.

An ACL allows one to permit or deny traffic from source IP addresses specified by a pair of source IP address and source wildcard. Note that the access list number of a standard ACL ranges from 1 to 99, and is unique for a given device/router. A mapping between ACL terminology and range dimension ordering is given in the table below. For instance, the source address range is identified as I₁, the source port is identified as I₂, etc.

TABLE
ACL Terminology and Dimension Order

| | |
|---|---|
| source | destination |

| address | port | address | port | protocol | action |
|---|---|---|---|---|---|
| I₁ | I₂ | I₃ | I₄ | I₅ | S |
| [a_{L}, a_{R}] | [s_{L}, s_{R}] | [d_{L}, d_{R}] | [t_{L}, t_{R}] | [p_{L}, p_{R}] | 1/0 |

A standard ACL entry can be formulated as I₁ [symbol] S, where I₁=[a_{L}, a_{R}] is a closed interval denoting the source address range and S denotes a classification action on the source address range (S=1/0 denotes the classification permit/deny action). Here, a_{L}=a_{R} means there is a single IP address.

A dotted decimal format IP address represented as d1.d2.d3.d4 can be uniquely converted to an integer form as Σᵢ₌₁⁴dᵢ256⁴⁻ⁱ and vice versa. Let aᵢ be a standard ACL entry written as aᵢ=(I₁,S)ᵢ, where the subscript i denotes the ith entry in the original order in an ACL. Its source address range and traffic classification is denoted by I(aᵢ) and S(aᵢ). The intersection of aᵢ and aⱼ is defined as the one-dimensional range intersection I₁(aᵢ)∩I₁(aⱼ).

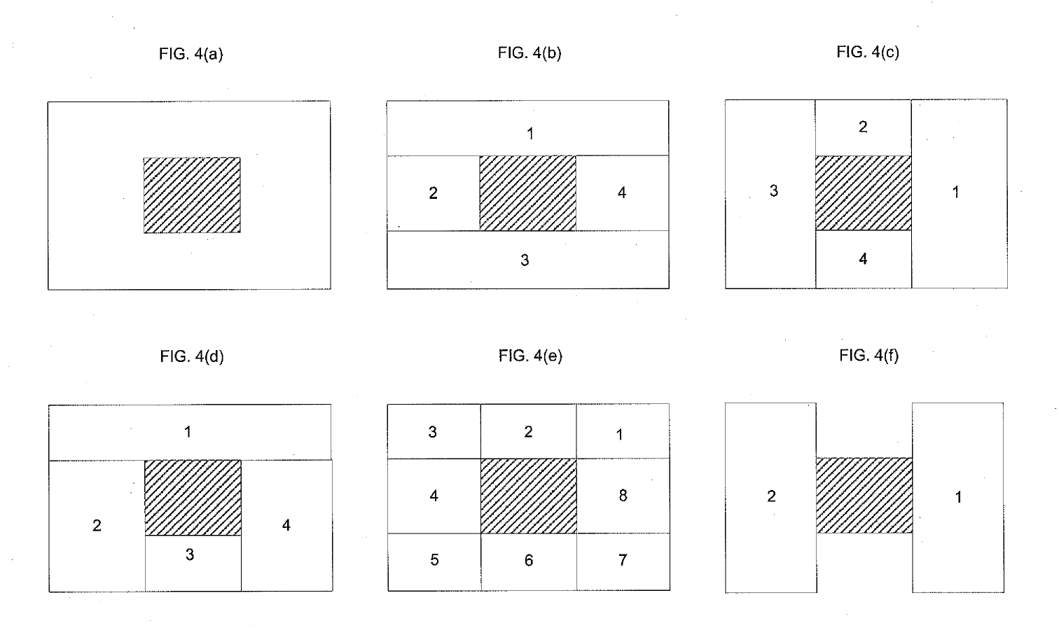

Analyzing the relationship between specific entries in a single ACL can be complex. Consider the following example with regard to FIGS. 4(a)-(f). These figures depict an ACL containing two rules that intersect with one another. One entry, a₁, is represented by a shaded rectangle, while the other entry, a₂, is represented by an unshaded region. In practice, the problem may be complicated because an ACL may include hundreds of entries in a multi-dimensional space.

In the present example, entry a₁ precedes entry a₂, and as a result, the scope of entry a₂ is altered (contracted) accordingly. Consequently, this is shown by a multiplicity of partitions. The altered/contracted areas are called spinoffs. The order-dependent effect on entry a₂ is the ratio of the sum volume of spinoffs to the original volume. In the case shown in FIGS. 4(a)-(f), the sum volume of spinoffs is equal to the area (scope) of a₂ minus the area of a₁.

The notion of a “d-box” is first considered for simplified problem formulation. As used herein, a d-box denoted by B^{d}, is the Cartesian product of I₁, . . . , I_{d} denoted as I₁ [symbol] . . . [symbol] I_{d} or [I₁, . . . , I_{d}]. Iᵢ(B^{d})=Iᵢ denotes the ith interval of B^{d}. A d-box is also referred to as a d-dimensional rectangle. It can be seen that a 1-box is an interval (range) in one-dimensional space, and a 2-box is a rectangle in two-dimensional space that is formed by the Cartesian product of two 1-boxes from two orthogonal dimensions.

Returning to FIGS. 4(a)-(f), in one example, a₁=([4,7],[4,7],0) (shaded rectangle in FIG. 4(a)), and a₂=([1,10],[1,10],1) (unshaded rectangle in FIG. 4(a)) (a₂ [symbol] a₁). The 2-box of a₂ [1,10] [symbol] [1,10] minus the 2-box of a₁ [4,7] [symbol] [4,7] could yield many distinct d-box partitions. FIGS. 4(b)-(e) depict four 2-box partitions with different sizes. The d-box partitions in FIGS. 4(b)-(d) have the size of 4 while one shown in FIG. 4(e) has the size of 8. FIG. 4(f) clearly is not a d-box partition because an unfilled area exists.

Translation of an order dependent ACL into its order-free equivalent it tantamount to identifying a d-box partition. The following table compares an order-dependent ACL versus an order-free equivalent.

TABLE
order-dependent ACL versus an order-free equivalent
Order dependent entry pair (a₁,a₂)

| | |
|---|---|
| ([4, 7], [4, 7], 0) | ([1, 10], [1, 10], 1) |

Order-free equivalent

| | | |
|---|---|---|
| ([1, 3], [1, 10], 1) | ([8, 10], [1, 10], 1) | ([4, 7], [1, 3], 1), |
| ([4, 7], [8, 10], 1) | ([4, 7], [4, 7], 0) | |

It should be noted that order independency does not necessarily mean semantic equivalency, as shown by the incomplete partition case of FIG. 4(f).

One process for converting order-dependent ACLs into order-free forms is shown in FIG. 5. Here, A is an order-dependent ACL (a₁, a₂, . . . , aₙ), and B represents its order-free equivalent, which is initially set to empty. Construction of the order-free form begins with removing aₙ from A and putting it as b₁ into B. This is done to generate spinoff entries. A spinoff entry represents an order-free entry after processing. For each entry aᵢ removed from A, one may substitute every entry bₖεB with bₖ's spinoff rules (V₁(I(aᵢ),I(bₖ)),S(bₖ)), and then put aᵢ into B. This process is continued until A is empty.

According to process 200, an entry higher in an ACL takes precedence over an entry which is lower. To reflect such a precedence ordering, a stack/queue (e.g., a LIFO queue) is created in which all the rules are pushed in sequentially with the highest one first. Then one entry is popped at a time. Because the latest popped entry has higher precedence ordering over all rules that have been popped so far, it is put in the order-free ACL being constructed as it is. All the other rules in the temporary order-free constructed so far are checked for any overlap with the latest one. If there is any overlap, the order-free rules constructed in previous steps are modified so that the spinoff rules have no overlap with the latest one, while at the same time maintaining the semantic equivalence.

Process 200 is explained as follows. The process is initialized at block 202, where a set of standard ACL rules (a₁, a₂, . . . , aₙ) are obtained, e.g., from a router's ACL list. A pair of local stacks or queues, e.g., a first queue “F” and a second queue “T” are initialized as shown at block 204. At block 206, the first queue F is populated with ACL rules aᵢ. This is repeated for all n rules.

As shown at block 208, the topmost entry a is obtained from the first queue F. Then, at block 210, a's relationship is checked with a first entry b in memory Q. In one example, memory Q is a LIFO stack. All rules in Q are order-free with respect to the original rules processed so far. All rules in F are intact and in the original order.

Each (original) rule in F (popped out in FILO fashion) needs to be compared with each rules in Q. If a rule popped out from F overlaps with a rule in Q, then the scope of the rule in Q needs to be modified so that the modified rule (which does not overlap with the rule in F) is then reinserted back to Q. Since rules in F precede rules in Q, when a rule popped out from F, it checks all rules in Q, and modifies the scope of rules if overlap occurs. After this check is completed, it is then inserted to Q. The process ends until F becomes empty, and then Q contains order-free rules (equivalents).

As shown in block 212, the process evaluates whether a overlaps b, contains b or is disjoint with b. Or does a enclose b. For instance, does aᵢ enclose aᵢ₊₁ such as is shown in FIG. 4C? If so, this signifies that b is redundant. In this case, the process proceeds to block 214 where b is flagged as redundant. If not, meaning that a either overlaps, contains or disjoins b, then the process proceeds to block 216. Here, one or more spinoffs of b are generated. For the case where the queue T is a LIFO queue, the spinoff may be created by putting the spinoff into T as follows: T·put((V₁(I(a),I(b)),S(b))). Then at block 218 these spinoffs are added to the second queue T.

The process then proceeds to block 220. Here, if the memory Q is not empty, e.g., one or more rules remain in a LIFO stack, the process returns to block 210, where a is evaluated against the next entry b. Otherwise, the process proceeds to block 222.

Here, if the first queue F is not empty, e.g., one or more a rules remain in a LIFO stack, then the process returns to block 208, where the next most recent entry a in the first queue F is obtained. Otherwise, the process proceeds to block 224. Here, any intermediate rules that are in the second queue T are transferred into memory Q. For instance, if second queue T is implemented as a stack-type storage memory, each entry is popped from the stack and placed in the memory Q, which may also be a stack-type memory. This is done until the second queue T is empty. Then, as shown in block 226, entry a is added from first queue F into memory Q. Each entry preferably represents a single rule of an ACL.

At block 228, optimization is performed to minimize the number of order-free rules. In one example, all rules may be sorted by the left endpoint in the interval in Q. Adjacent rules having the same classification status may be merged as part of the minimization process. For instance, two rules aᵢ=(I₁,S)ᵢ and aⱼ=(I₁,S)ⱼ are said to be adjacent iff (a_{L})_{I}=(a_{R})ⱼ+1 or (a_{L})ⱼ=(a_{R})_{I}+1. Then, as shown in block 230, the results from Q—order-free equivalents—may be provided, e.g., to a user via a graphical user interface or stored electronically for later analysis. Then the process ends as shown at block 232.

A pseudocode representation of the process 200 is shown in FIG. 6. As shown here, a given firewall rule set is stored in a stack F. The rule set is converted into order-free (spinoff) rules stored in stack F′. The conversion process may be performed by the system for each ACL to be evaluated.

As discussed above with regard to FIG. 3, once the order-free configuration for a given ACL has been determined, the set of positive (permit) entries for the order-free configuration may be obtained. An exemplary pseudocode representation of this process is shown in FIG. 7. Here, the process begins by obtaining an order-free equivalent of the ACL as discussed above with regard to FIGS. 3 and 6. Then each rule a in the order-free equivalent is evaluated to determine whether it is a “permit” entry. As shown in the figure, D(a)=1 means that the action of corresponding entry is “permit”. If the rule is a permit entry, then it is placed in stack Q. If it is not (i.e., it is a “deny” entry), then it may be discarded or otherwise ignored. Once all rules have been evaluated, the stack Q containing all positive (order-free) rules may be provided to the system for subsequent processing.

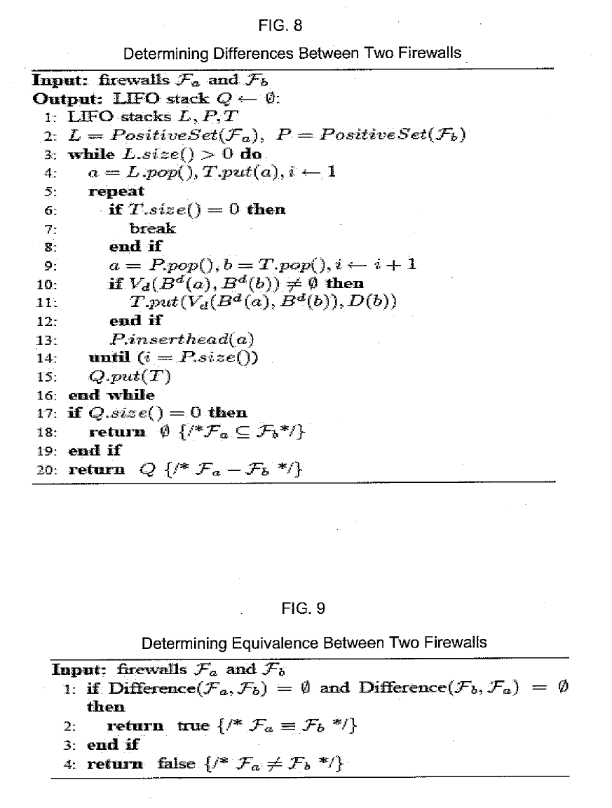

FIG. 8 illustrates an exemplary process for determining the difference between a pair of firewalls as addressed in block 106 of FIG. 3. Here, two firewalls are evaluated. As discussed above with regard to FIG. 3, the order-free ACL configurations (Fₐ and F_{b}) and the sets of permit entries for each order-free equivalent are employed (PositiveSet(Fₐ) and PositiveSet(F_{b})) in determining the difference between the firewalls. If there is no difference between the firewalls, then a null set is returned. Otherwise, the difference (Fₐ−F_{b}) that is stored in stack Q is returned. Here, if there is a difference between the two firewalls, the process identifies what is permitted by Fₐ but not F_{b}. By swapping the inputs, the system may determine what is permitted by F_{b} but not Fₐ. Desirably, the system performs both differences to obtain a more robust understanding of the firewalls. As noted above, the difference between firewalls may be asymmetric, i.e., Fₐ−F_{b}≠F_{b}−Fₐ. This is illustrated in FIG. 8A.

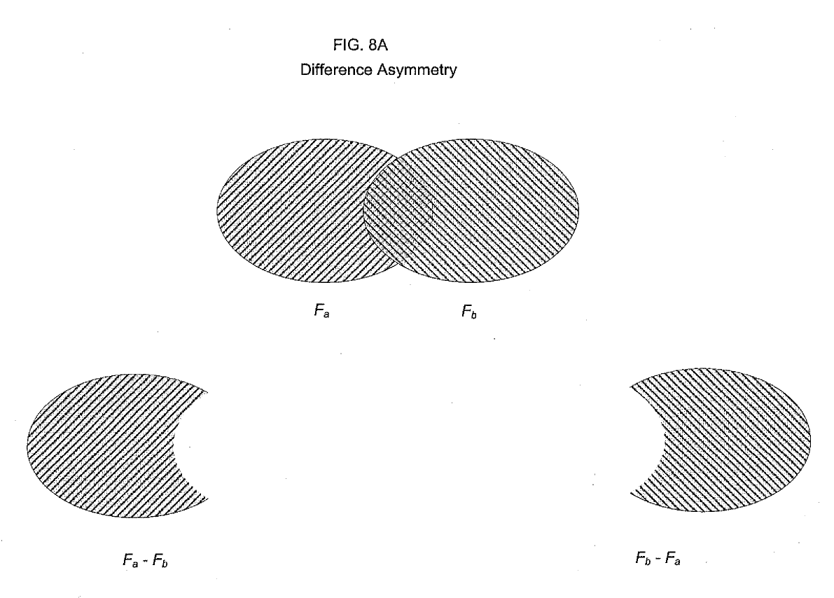

FIG. 9 illustrates an exemplary process for determining equivalence between a pair of firewalls as addressed in block 106 of FIG. 3. Two standard ACLs A and B are said to be equivalent iff A⊂B and B⊂A. Thus, for any given traffic from an arbitrary source address range that is denied and permitted by A, it will also be denied and permitted by B, and vice versa. As shown in FIG. 9, if there are no differences according to the processing of FIG. 8 (for both Difference(Fₐ,F_{b}) and Difference(Fₐ,F_{b}), then there is equivalence between the firewalls. Otherwise, there is no equivalence.

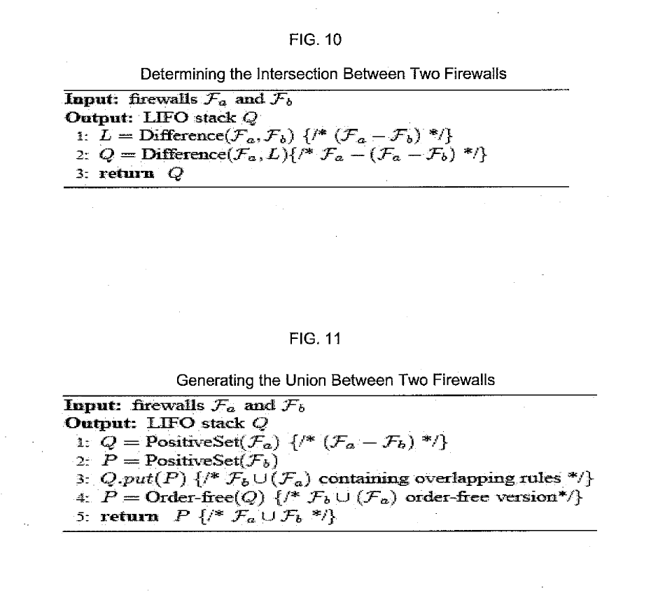

FIG. 10 presents an exemplary process for determining the intersection between a pair of firewalls. Here, once the order-free equivalents, permit entries for the order-free equivalents, and differences between the firewalls (if any) have been determined, the intersection (if any) of a pair of firewalls may be found. As shown, in step 1 the system determines the difference between Fₐ and F_{b}, which provides the portion of Fₐ not in F_{b}. And in step 2, the system determines the difference between Fₐ and the output of the first step. The result, which may be stored in stack Q, contains any intersection between the firewalls.

And FIG. 11 presents an exemplary process for generating the union between a pair of firewalls. Here, once the order-free equivalents have been determined, the union (if any) of a pair of firewalls may be found. As shown, in steps 1 and 2 the system determines the permit entries for Fₐ and the positive entries for F_{b}. In step 3, the entries for F_{b} are appended to the entries for Fₐ. The results are desirably analyzed according to the process as described above for FIG. 7.

As discussed above, the results of the processes of FIGS. 6-11 may be used by the system to check security compliance involving multiple ACLs. For instance, if multiple firewalls are employed such as in the configuration shown in FIG. 2 or in some other configuration, the system may use these processes to ensure consistency and maintain security requirements for the respective firewalls. Two examples are provided below. First, assume there is traffic between devices 12 and 24a of FIG. 1. For example, a web browser running on computer 12 is allowed to access a web server 24a. To ensure this, the traffic should be permitted by inbound ACL on network interface 14 (FIG. 1) and on network interface 42b (FIG. 2) as well as outbound ACL on network interface 14 (FIG. 1) and on network interface 42b (FIG. 2) (if the outbound ACLs exist). The intersection of all ACLs on the path from 12 and 24a should be computed. In another example, assume a requirement states that all traffic being permitted by ACL 42b should be permitted by ACL 18. Verification of this condition is reduced to a firewall inclusion, which is a special case of firewall difference. This is done by checking the result of the difference between ACLs 18 and 42b. If ACL 18 minus ACL 42b is empty, the answer is yes (the condition is verified). Otherwise, the answer is no (the condition is not verified).

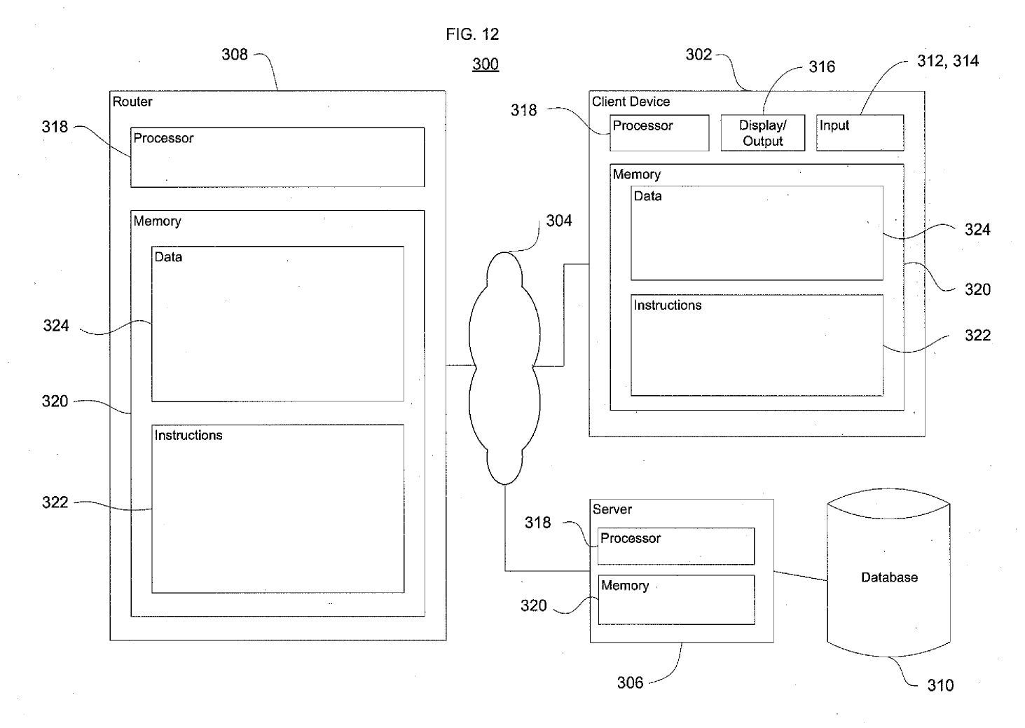

By way of example only, aspects of the invention may be implemented using a computer network such as shown in FIG. 1 or as shown in FIG. 12. As shown in FIG. 12, computer network 300 may include a client device 302, which may be a desktop or laptop computer, or may be another type of computing device such as a mobile phone, PDA or palmtop computer. The client device 302 may be interconnected via a local or direct connection and/or may be coupled via a communications network 304 such as a Local Area Network (“LAN”), Wide Area Network (“WAN”), the Internet, etc.

The client device 302 may couple to a server 306 via router 308. The server 306 is desirably associated with database 310, which may provide content to the client device 302 if access control list criteria are satisfied. The router 308 may include a firewall (not shown) and maintain an ACL therein.

Each device may include, for example, one or more hardware-based processing devices and may have user inputs such as a keyboard 312 and mouse 314 and/or various other types of input devices such as pen-inputs, joysticks, buttons, touch screens, etc. Display 316 may include, for instance, a CRT, LCD, plasma screen monitor, TV, projector, etc.

The user device 302, server 306 and router 308 may contain at least one processor, memory and other components typically present in a computer. As shown, the router 308 includes a processor 318 and memory 320. Components such as a transceiver, power supply and the like are not shown in any of the devices of FIG. 12.

Memory 320 stores information accessible by the processor 318, including instructions 322 that may be executed by the processor 318 and data 324 that may be retrieved, manipulated or stored by the processor. The firewall may be implemented by the router 308, where the ACL(s) is stored in memory 320. The memory 320 may be of any type capable of storing information accessible by the processor, such as a hard-drive, ROM, RAM, CD-ROM, flash memories, write-capable or read-only memories.

The processor 318 may comprise any number of well known processors, such as processors from Intel Corporation or Advanced Micro Devices. Alternatively, the processor may be a dedicated controller for executing operations, such as an ASIC.

The instructions 322 may comprise any set of instructions to be executed directly (such as machine code) or indirectly (such as scripts) by the processor. In that regard, the terms “instructions,” “steps” and “programs” may be used interchangeably herein. The instructions may be stored in any computer language or format, such as in object code or modules of source code. The functions, methods, pseudocode and routines of instructions in accordance with the present invention as explained herein—such as those presented in FIGS. 3 and 5-11—may be executed by the processor 318 of server 606.

Data 324 may be retrieved, stored or modified by processor 318 in accordance with the instructions 322. The data may be stored as a collection of data. For instance, although the invention is not limited by any particular data structure, the data may be stored in computer registers, in a relational database as a table having a plurality of different fields and records. In one example, the memory 320 may include one or more stacks or queues for storing the data. In one example, the stacks/queues are configured as LIFOs.

The data may also be formatted in any computer readable format. Moreover, the data may include any information sufficient to identify the relevant information, such as descriptive text, proprietary codes, pointers, references to data stored in other memories (including other network locations) or information which is used by a function to calculate the relevant data.

Although the processor 318 and memory 320 are functionally illustrated in FIG. 12 as being within the same block, it will be understood that the processor and memory may actually comprise multiple processors and memories that may or may not be stored within the same physical housing or location. For example, some or all of the instructions and data may be stored on a removable CD-ROM or other recording medium and others within a read-only computer chip. Some or all of the instructions and data may be stored in a location physically remote from, yet still accessible by, the processor 318. Similarly, the processor 318 may actually comprise a collection of processors which may or may not operate in parallel. Data may be distributed and stored across multiple memories 320 such as hard drives or the like.

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the invention as defined by the appended claims.

While certain processes and operations have been shown in certain orders, it should be understood that they may be performed in different orders and/or in parallel with other operations unless expressly stated to the contrary.

1. A method of processing access control lists in a computer network, the method comprising:
obtaining a plurality of access control lists and storing the plurality of access control lists in memory, the access control lists each comprising a plurality of rules for permitting or denying access to resources in the computer network;
generating an order-free equivalent for each of the plurality of access control list;
storing the order-free equivalents for the plurality of access control lists;
determining a set of permit entries from each order-free equivalent to identify which of the plurality of rules permit the access to the resources in the computer network; and
using the order-free equivalents for each of the plurality of access control lists and the set of permit entries from each order-free equivalent to manage firewall operations in the computer network.

2. The method of claim 1, wherein the method further comprises:
generating any differences between first and second ones of the access control lists upon determining the set of permit entries associated with the first and second access control lists.

3. The method of claim 2, further comprising analyzing whether the first and second access control lists are equivalent upon generating any differences between the first and second access control lists.

4. The method of claim 2, further comprising analyzing whether an intersection exists between the first and second access control lists upon generating any differences between the first and second access control lists.

5. The method of claim 1, further comprising analyzing whether a union exists between the first and second access control lists upon determining the set of permit entries from each order-free equivalent.

6. An apparatus for processing access control lists in a computer network, the apparatus comprising:
memory for storing information associated with a plurality of access control lists; and
processor means for obtaining a plurality of access control lists and storing the plurality of access control lists in memory, the access control lists each comprising a plurality of rules for permitting or denying access to resources in the computer network; generating an order-free equivalent for each of the plurality of access control list; storing the order-free equivalents for the plurality of access control lists; determining a set of permit entries from each order-free equivalent to identify which of the plurality of rules permit the access to the resources in the computer network; and using the order-free equivalents for each of the plurality of access control lists and the set of permit entries from each order-free equivalent to manage firewall operations in the computer network.

7. The apparatus of claim 6, wherein the processor means is further configured for generating any differences between first and second ones of the access control lists upon determining the set of permit entries associated with the first and second access control lists.

8. The apparatus of claim 6, wherein the processor means is further configured for analyzing whether the first and second access control lists are equivalent upon determining any differences between the first and second access control lists.

9. The apparatus of claim 6, wherein the processor means is further configured for analyzing whether an intersection exists or generating an intersection between the first and second access control lists upon determining any differences between the first and second access control lists.

10. The apparatus of claim 6, wherein the processor means is further configured for analyzing whether a union exists between the first and second access control lists upon determining the set of permit entries from each order-free equivalent.

11. A computer-readable recording medium having instructions stored thereon, the instructions, when executed by a processor, cause the processor to perform a method of processing access control lists in a computer network, the method comprising:
obtaining a plurality of access control lists and storing the plurality of access control lists in memory, the access control lists each comprising a plurality of rules for permitting or denying access to resources in the computer network;
generating an order-free equivalent for each of the plurality of access control list;
storing the order-free equivalents for the plurality of access control lists;
determining a set of permit entries from each order-free equivalent to identify which of the plurality of rules permit the access to the resources in the computer network; and
using the order-free equivalents for each of the plurality of access control lists and the set of permit entries from each order-free equivalent to manage firewall operations in the computer network.

12. The computer-readable recording medium of claim 11, wherein the method further comprises:
generating any differences between first and second ones of the access control lists upon determining the set of permit entries associated with the first and second access control lists.

13. The computer-readable recording medium of claim 12, wherein the method further comprising analyzing whether the first and second access control lists are equivalent upon generating any differences between the first and second access control lists.

14. The computer-readable recording medium of claim 12, the method further comprising analyzing whether an intersection exists between the first and second access control lists upon generating any differences between the first and second access control lists.

15. The computer-readable recording medium of claim 11, the method further comprising analyzing whether a union exists between the first and second access control lists upon determining the set of permit entries from each order-free equivalent.
